(19) United States
(12) Patent Application Publication
(10) Pub. No.: US 2012/0091943 A1
(43) Pub. Date: Apr. 19, 2012

(54) SOLAR CELL CHARGING CONTROL

(76) Inventors: Dror Manor, Hertzlia (IL); Daniel Breiting, Zerufa (IL)

(21) Appl. No.: 13/376,844

(22) PCT Filed: Jun. 8, 2010
(86) PCT No.: PCT/IL10/00452

§ 371 Date: Jan. 3, 2012

Related U.S. Application Data
(60) Provisional application No. 61/213,428, filed on Jun. 8, 2009.

(51) Int. Cl. H02J 7/00

(52) U.S. Cl. 320/101

(57) ABSTRACT

To prevent the battery of a solar charged device from discharge when insufficient solar radiation is present, a control circuit is provided to disable the charging circuits under those conditions. A current load is applied to the output of the solar cell, and the level of power drawn by this load from the solar cell is measured. Control circuits disable the charging circuits of the device when the signal from the current monitor indicates that insufficient solar power is detected. The monitor current load should be such that the power drawn by it should be at least of the same order as the power required by the charging circuitry for its quiescent operation. A series switch may be used so that current is drawn through the load only when solar output is sufficient to enable charging. Alternatively, a periodically pulsed switch may be used to limit the load current.

### FIELD OF THE INVENTION

The present invention relates to the field of solar cell power sources for providing load current to a device, and especially to control of the current drawn from the solar cell so as to avoid depletion of the internal batteries of the mobile device.

### BACKGROUND OF THE INVENTION

Solar cells have a number of characteristics which are important in order to optimize their efficiency in charging mobile devices. Because of the space and weight premium on a mobile device such as a cellular phone, both the solar cell and the battery are generally made as small and light as possible. As a result, the power budget of the charging and battery system is critical, and every effort must be made to ensure optimum efficiency in the use of these components. Therefore, it is important that no energy be wasted by powering circuits when there is no need for their function.

There exists a potential problem with the charging of batteries of mobile devices using solar cells, since under some situations, the internal battery of the mobile device itself can be discharged rather than charged. This situation can occur when there is little incident solar energy, and the energy demanded just to power the charging circuits, without providing any charge to the internal battery itself, may be larger than that generated by the solar cell. This results in a discharge of the internal battery to power the charging circuits, rather than a charging of the internal battery. In order to prevent this from happening, a control circuit is required to disable the charging circuits of the solar charger when insufficient solar power is available. The control circuit itself, which usually always has to be maintained in a condition to be ready to maintain control of the system, needs for its self consumption only a very small fraction of the self consumption power of the charging circuits, such that it need not be disabled to save consumption.

The disclosures of each of the publications mentioned in this section and in other sections of the specification, are hereby incorporated by reference, each in its entirety.

### SUMMARY OF THE INVENTION

The present disclosure describes new exemplary systems for the control of the current drawn from a solar cell or an array of solar cells, typically in applications where the solar cell(s) is used for charging the internal battery of a portable device. Conventional charging circuits (generally understood to include the DC/DC up-converter and their associated charge control circuits) are generally continuously powered, and always available for converting the solar cell output current for use in charging the internal battery of the device. The systems described in the present disclosure, on the other hand, disable the charging circuits under: those situations where, because of a low level of solar incident power, the maximum current that can be supplied by the solar cell(s) is less than that required for just powering the charging circuits. Without such a system, under low incident solar radiation conditions, the current required to power the charging circuits would be drawn from the internal battery of the device, resulting in reduction of the battery charge rather than an increase of its charge from the solar input.

Besides the solar cell and charger, such mobile devices often also include an external charger input to enable the charging of the internal battery from an external source, such as a wall charger or a car battery output socket. Such an external charging input may have its own charging and control circuitry, or it may use the solar cell charging and control circuitry through an auxiliary input. Additionally, in applications where mains power may not be readily available but where there is an abundance of solar power, such as in some tropical countries, the solar charger may be the sole means of charging the device's internal batteries. The exemplary circuits described in the present disclosure relate only to the solar cell charging circuitry, but it is to be understood that this charging circuitry could be common to, or in parallel to, charging circuitry for handling power inputs from external sources other than the solar cell(s), and this disclosure is meant to include such implementations also.

Furthermore, the use of the term charging circuitry or charging circuits, when relating to the current consumption necessary for operating these circuits, is intended generally to include both the DC-DC up-converter for converting the solar cell output current to a voltage suitable to charge the internal battery, and the battery charge control circuits themselves, including any related ancillary circuits.

In order to achieve the desired protection of the internal battery of the device from unnecessary discharge when insufficient solar radiation is present, a control circuit is provided to disable the charging circuits of the solar charger when insufficient solar power is available. The exemplary systems of the present disclosure utilize a monitor current load applied to the output of the solar cell, and a current monitor, to detect the level of power drawn by this load from the solar cell as a result of the incident solar radiation falling on it. Control circuits are described for disabling the charging circuits of the device when the signal from the current monitor indicates that insufficient solar power is detected. The monitor current load should be of such a value that the power drawn by it from the solar cell should be of the same order as the power required by the charging circuitry for its quiescent operation. This quiescent operation power is also variously described as the standby power, or The self consumption power, or the non-operational mode power, and it is intended to mean in this disclosure, the power used by the charging circuitry when it is not operative in delivering any charge current. If the load is designed such that the load current with minimal solar radiation is much less than that level, the load will not provide a meaningful measure of when the solar radiation is sufficient to power the charging circuits. If the loading current is much more than that level, the load will waste power available from the solar cell, diverting it from use within the true load, such as the device which it is meant to be powering and its internal battery which it is meant to be charging. In practice, the optimum selected level of the load cannot therefore be defined rigidly, but it should be selected by the circuit designer to be of such a level that the power drawn by it from the solar cell should be at least close to the power level required to power the charging circuitry itself, besides the charging current it is supplying to the battery.

When the output from the current monitor indicates that the power drawn from the solar cell is less than the selected threshold level, generally below that at which the solar cell would not even be able to provide the quiescent current to the charging circuits, the current control circuit may be disabled, so that the internal battery of the device is not discharged. Since the solar cell(s) cannot provide any meaningful charge current when there is insufficient solar radiation, the disablement of the charging circuitry has no significance on the charging ability of the solar charging system. The charging circuitry may be aroused only when the solar cell provides sufficient output to ensure that the internal battery is not the only source for powering the charging circuitry, at which point the current monitor can be adapted to provide an enabling pulse to the charge control circuit to arouse it.

In order to avoid loading the solar cell(s) continuously, a controlled switch such as A MOSFET may be provided in the loading circuit to disconnect it when the solar cell output is sufficiently high that it is providing current at at least the level needed to provide power to operate the charge circuitry. In addition, a circuit function should be provided to maintain the charge circuitry powered while the switch is open, and to close the switch so that the solar cell output can be monitored, if the solar cell output current again falls below the threshold value.

As an alternative to having the load resistor connected continuously to the solar cell, at least when the solar cell is not providing sufficient output to power the charge circuits, a pulsed switch may be used, which periodically connects the monitor load to the solar cell(s), in order to periodically check the solar cell output. A typical ON-OFF ratio of 20:1 could be used, with an ON time of a few millisecs and an OFF time of a few hundred millisecs, though these values may be adapted to suit the particular requirements or characteristics of the circuits involved.

There is thus provided in accordance with one exemplary implementation of the devices described in this disclosure, a system for controlling the power supplied by at least one solar cell for charging the battery of a device, the system comprising:
(i) charging circuitry for charging the battery from the output of the at least one solar cell,
(ii) a load, in addition to the device, for connection to the at least one solar cell to draw current therefrom, the current providing a measure of the power drawn by the load from the at least one solar cell, and
(iii) control circuitry using the measure of power to disable the charging circuitry when the power drawn from the at least one solar cell is less than a predetermined level.

In such a system; the predetermined level of power may be at least that required to supply the quiescent power to the charging circuitry.

Additional implementations of these systems can incorporate a switch disposed so as to control the connection of the load to the at least one solar cell. The switch may be closed when the at least one solar cell is outputting power above the predetermined level. It may be actuated by the control circuitry. Additionally, the switch may be closed only periodically, and according to one exemplary implementation, this periodic closing of the switch is such that loading of the at least one solar cell in order to measure its output power, is minimized. The switch may be an electronically gated switch, such as a field effect transistor. Additionally, the load may be a resistive load.

Furthermore, in any of the above-described switch operated systems, the switch may be operated to be opened when the at least one solar cell is outputting power distinctly above the predetermined level, such that the load does not draw current from the at least one solar cell when the at least one solar cell is supplying power distinctly above the predetermined level.

Another example implementation can involve a system as described above, in which the predetermined level of power is such that the at least one solar cell provides a net charging current to the battery after powering the charging circuitry.

Yet other implementations perform a method of preventing the discharge of the battery of a device charged by at least one solar cell, when the incident solar radiation is insufficient to charge the battery, the method comprising:
(i) connecting a load, in addition to the device, to the at least one solar cell to draw current therefrom through the load,
(ii) using the load current to determine a measure of the power drawn by the load from the at least one solar cell, and
(iii) using the measure of power to disable the charging circuitry when the power drawn from the at least one solar cell is less than a predetermined level of power.

In this method, the predetermined level of power may be at least that required to supply the quiescent power to the charging circuitry.

Additional implementations of these methods can incorporate the step of disposing a switch to control the connection of the load to the at least one solar cell. The switch may be closed when the at least one solar cell is outputting power above the predetermined level, and it may be actuated by the control circuitry. Additionally, the switch may be closed only periodically, and according to another exemplary implementation of these methods, this periodic closing of the switch may be such that loading of the at least one solar cell in order to measure its output power, is minimized. The switch may be an electronically gated switch, such as a field effect transistor. Additionally, the load may be a resistive load.

Furthermore, any of the above-described switch operated methods may include the additional step of opening the switch when the at least one solar cell is outputting power distinctly above the predetermined level, such that the load does not draw current from the at least one solar cell when the at least one solar cell is supplying power distinctly above the predetermined level.

Another exemplary implementation can involve any of the methods described above, in which the predetermined level of power is such that the at least one solar cell provides a net charging current to the battery after powering the charging circuitry.

Although the systems and methods are described in this disclosure with specific reference to a battery charging application for a mobile electronic device, it is to be understood that the invention is not intended to be limited to such an application, but is equally applicable to any other application involving the use of solar cells to charge a battery under differing illumination conditions.

### BRIEF DESCRIPTION OF THE DRAWINGS

The presently claimed invention will be understood and appreciated more fully from the following detailed description, taken in conjunction with the drawings in which:

FIG. 1 is a schematic diagram of a prior art solar cell charging circuit, for charging the battery of a mobile device, such as a cellular phone;

FIG. 2 illustrates a solar cell charge control system for ensuring that the charging circuits are not powered unless there is sufficient solar power available to ensure that they do not impose a current drain on the internal battery; and

FIG. 3 illustrates an alternative exemplary solar cell charge control system to that shown in FIG. 2.

### DETAILED DESCRIPTION

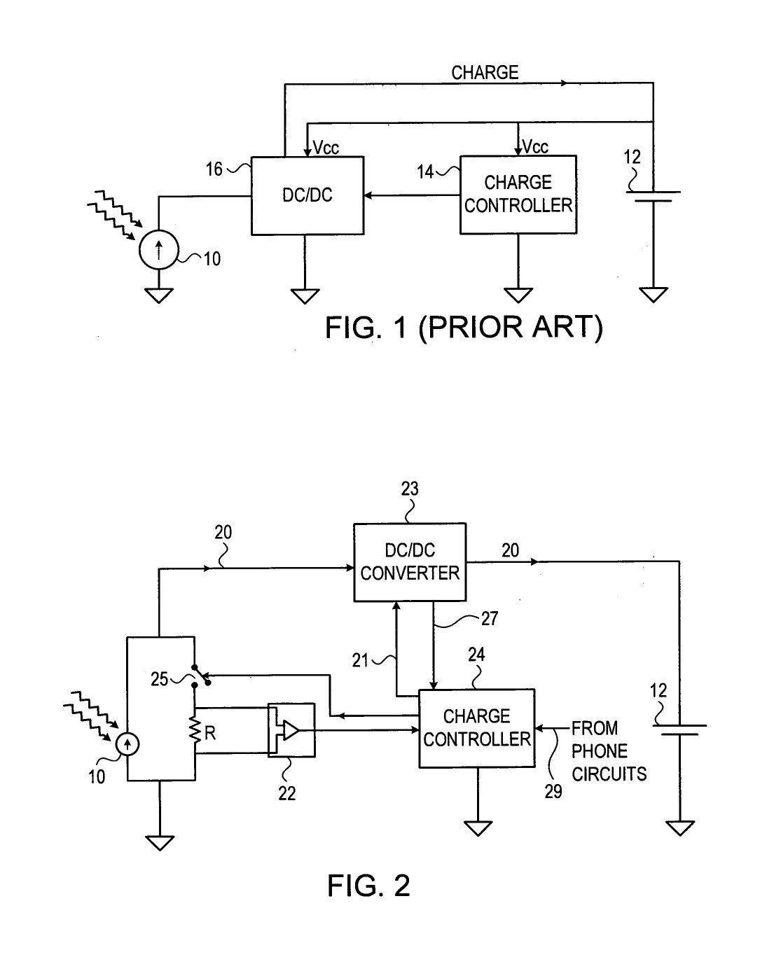

Reference is now made in FIG. 1, which is a schematic diagram of a prior art solar cell 10 charging circuit, for charging the internal battery 12, of a mobile device, such as a cellular phone. A cellular phone is used as the example in the implementations shown in all of this section, though it is to be understood that the invention is not meant to be limited thereto. Although this circuit shows only a solar cell charger, it is to be understood that there could also be additional inputs from external voltage sources, which could use the same charging circuitry as the solar cell, or dedicated charging circuitry. This is applicable not only to the implementation of FIG. 1 but to all the other implementations shown in this disclosure. The battery 12 not only powers the operative circuits of the mobile device, but it also supplies power to the charge controller 14 of the mobile device, and to the DC-DC converter 16 used to up-convert the voltage from the solar cell to a level suitable for charging the internal battery 12. It is important that no energy be wasted by powering these charging circuits when there is no need for their function, such as when the solar cell cannot provide sufficient output to deliver useful charging power.

The novel charge control systems described in this disclosure prevent this energy wastage by disabling the charging circuits, namely, the charge controller 14 and the DC/DC up-converter 16, when there is insufficient solar radiation to provide the minimum required charge current from the solar cell to power these charging circuits. This minimum level, as described in the Background of the Invention section of this application, is such that it avoids a net discharge of the device's internal battery 12 to power the charging circuits, rather than their being powered by the solar cell 10. The voltage output of the solar cell is not generally a good parameter to use as the criterion for determining whether the solar cell can provide sufficient output to power the charging circuitry. This is because when there is no load applied to the solar cell, such as when the phone is not operating and the battery is fully charged, the output voltage of the solar cell will be high even when there is little incident solar radiation, since no current is being drawn from the solar cell.

Instead of using the voltage output of the solar cell, the circuitry of the presently described charging system operates by making a direct measurement of the power which can be drawn from the solar cell at any time, so that this can be used as a threshold level for deciding at what level of solar cell output power the charging system should be shut down. The present circuit does this by checking the power output from the solar cell, and arousing the charging circuitry only if the solar cell is receiving sufficient solar radiation to enable it to generate enough power to power at least the charging circuits themselves. The monitoring of the output power of the solar cell can be performed by loading the solar cell such that it draws a load current besides that for the power drawn by the mobile device's battery load and its internal control circuitry, and by measuring the current drawn just by this additional load. This loading can either be performed continuously, or it can be performed periodically using a pulsed system.

Reference is now made to FIG. 2, which illustrates one exemplary circuit design by which this can be achieved. In FIG. 2, the main output line 20 from the solar cell 10 goes to powering the mobile device and charging its internal battery 12 by means of a DC/DC up-converter 23. In FIG. 2, only the internal battery of the mobile devices is shown. The up-converter is controlled by a charge controller 24, which, using control signal inputs 29 from the mobile device, such as the internal battery charge level or the mobile device current requirement, controls the charge rate of current transferred from the solar cell to the mobile device. In addition to the regular charging circuitry, a current measurement resistor load R, is connected across the output of the solar cell in a separate circuit. When the switch 25, whose full function will be described below, is closed, the current measurement resistor R draws current from the solar cell 10, and the level of this current is measured by the current probe circuit 22. The value of R is chosen so as to take only a small part of the solar cell output power, but this small part of the output power should be at least as large as the power required for operation of the up-converter circuit 23 and the charge controller circuit 24. The signal from this current probe circuit 22, which may also be compared with some predetermined reference level using for instance, a comparator, as is known in the art, is input to charge controller 24. When it reaches a level such that the solar cell can provide the minimum power required to maintain a positive power budget for the phone battery after providing for the charging circuit powering needs, the charge controller's DC/DC converter control function is enabled. This then provides an enabling signal 21 to turn on the DC/DC converter, allowing flow of current from the solar cell to charge the battery.

Although it correctly determines the point at which the charging circuits can be aroused from their deactivated mode, the load resistor would also continuously divert part of the output current of the solar cell, if steps were not taken to prevent this. In order to avoid this situation, a switch 25 may be provided in the load circuit, which may be opened by a control circuit in the charge controller 24 when the current supplied by the solar cell is sufficient to enable charging. A latching function should be provided by the charge controller 24 so that the charging function is not disabled again immediately. Without such a latching function, this arrangement would lead to a continuous ON-OFF oscillation of the enabled charging power. Such a latching function could be implemented by adapting the current probe circuit 22 to output an enabling pulse to turn on the charge controller, rather than a continuous hold signal. However, in order to disertable the charging circuitry should the solar cell output again fall below the predetermined level, logic control should be provided by a current monitor in the supply line 20, to disenable charging in such a situation, and to close the load resistor circuit switch 25 again, so that the current monitor will again function to detect when the charging circuitry can be aroused again. The current monitor could be provided by the DC/DC converter itself, or from a signal 27 provided by the DC/DC converter to the charge controller.

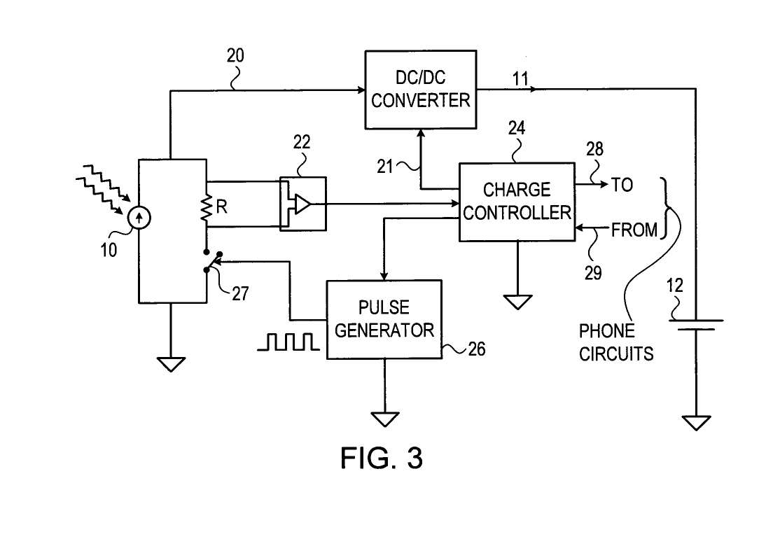

Reference is now made to FIG. 3, which illustrates an alternative exemplary solar cell charge control system, which overcomes in a different manner, the problem of the continuous loading of the solar cell by the current probe load R. This implementation is similar to that shown in FIG. 2, with the exception that the load resistor R only loads the solar cell intermittently. A switch 27, such as a MOSFET, is provided in the load current path, and it may be pulsed such that it has a short signal/space ratio. The pulses may be generated by means of a pulsing circuit 26, or the pulsing circuit 26 may be triggered by the charge controller 24, or the pulses may be output directly from the charge controller 24. Typically the switch may be off for 500 msec. and turned on for 4 msec., though any other suitable pulse ON-OFF ratio may be used.

In operation, during the period that the pulse is on and the switch 27 closed, the current I provided by the solar cell through the load R is measured. If I is above the predefined threshold level, which is generally defined as a current sufficient for the solar cell to at least ensure that current can be supplied at a level sufficient to power the charging circuitry for the internal battery 12, an enabling pulse 28 is provided to activate the internal charging circuitry, whether this is the DC-DC converter itself, or whether this is separate from the solar cell charging circuitry 23, 24. This enables the solar cell to at least power the charging circuitry of the, mobile device. By this means the solar cell is only allowed to provide an output to enable charging of the mobile device and its charging circuitry if the solar radiation is at such a level that there is a positive input of power, and not an outflow of power from the battery to the charging circuit.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A system for controlling the power supplied by at least one solar cell for charging the battery of a device, said system comprising:
charging circuitry connected to the output of said at least one solar cell for charging said battery from the output of said at least one solar cell;
a load for connection in parallel to said device to said at least one solar cell, to draw current therefrom, said current providing a measure of the power drawn by said load from the at least one solar cell;
a switch disposed so as to control the drawing of said current by said load from said at least one solar cell; and
control circuitry using said measure of power to disable said charging circuitry when said power drawn from said at least one solar cell is less than a predetermined level.

2. A system according to claim 1, wherein said predetermined level of power is at least that required to supply the quiescent power to said charging circuitry.

3-4. (canceled)

5. A system according to claim 1, wherein said switch is actuated by said control circuitry.

6. A system according to claim 5, wherein said switch is closed only periodically.

7. A system according to claim 6, wherein said periodic closing of said switch is such that loading of said at least one solar cell by said load in order to measure its output power, is minimized.

8. A system according to claim 1, wherein said switch is opened when said at least one solar cell is outputting power distinctly above said predetermined level, such that said load does not draw current from said at least one solar cell when said at least one solar cell is supplying power distinctly above said predetermined level.

9. A system according to claim 1, wherein said switch is an electronically gated switch.

10. A system according to claim 9, wherein said switch is a field effect transistor.

11. A system according to claim 1, wherein said load is a resistive load.

12. A system according to claim 1, wherein said predetermined level of power is such that said at least one solar cell provides a net charging current to said battery after powering said charging circuitry.

13. A method for controlling the power supplied by at least one solar cell for char in the battery of a device through charging circuitry, said method comprising:
connecting a load, in parallel to said device, to said at least one solar cell by means of a switch, in order to draw current from said solar cell through said load;
using said load current to determine a measure of the power drawn by said load from the at least one solar cell; and
using said measure of power to disable said charging circuitry when said power drawn from said at least one solar cell is less than a predetermined level of power, such that current is not drawn from said battery of said device to power said charging circuitry when said at least one solar cell outputs less than said predetermined level of power.

14. A method according to claim 13, wherein said predetermined level of power is at least that required to supply the quiescent power to said charging circuitry.

15-17. (canceled)

18. A method according to claim 14 wherein said switch is closed only periodically.

19. A method according to claim 18 wherein said periodic closing of said switch is such that loading of said at least one solar cell by said load in order to measure its output power, is minimized.

20. A method according to claim 14, further comprising the step of opening said switch when said at least one solar cell is outputting power distinctly above said predetermined level, such that said load does not draw current from said at least one solar cell when said at least one solar cell is supplying power distinctly above said predetermined level.

21. A method according to claim 14, wherein said switch is an electronically gated switch.

22. A method according to claim 14, wherein said switch is a field effect transistor.

23. A method according to claim 14, wherein said load is a resistive load.

24. A method according to claim 14, wherein said predetermined level of power is such that said at least one solar cell provides a net charging current to said battery after powering the charging circuitry.

25. A method according to claim 14, wherein said method prevents drawing of current from said battery of said device for powering said charging circuitry when there is insufficient power from said at least one solar cell to provide current to charge said battery.
